(19) United States
(12) Patent Application Publication
(10) Pub. No.: US 2021/0273529 A1
(43) Pub. Date: Sep. 2, 2021

(54) ROTOR, MOTOR, FAN, AIR CONDITIONING APPARATUS, AND METHOD FOR MANUFACTURING ROTOR

(71) Applicant: Mitsubishi Electric Corporation, Tokyo (JP)

(72) Inventors: Hiroki ASO, Tokyo (JP); Takaya SHIMOKAWA, Tokyo (JP); Junichiro OYA, Tokyo (JP); Naoki TAMURA, Tokyo (JP)

(21) Appl. No.: 17/255,100

(22) PCT Filed: Aug. 2, 2018
(86) PCT No.: PCT/JP2018/029005

§ 371 Date: Dec. 22, 2020

(51) Int. Cl. H02K 11/215; H02K 1/27; H02K 7/08; H02K 21/14; H02K 15/03; F24F 7/013

(52) U.S. Cl. CPC H02K 11/215; H02K 1/2733; F24F 7/013; H02K 21/14; H02K 15/03; H02K 7/083

(57) ABSTRACT

A rotor includes a resin magnet and a shaft fixed to the resin magnet. The resin magnet includes a first magnetic flux generating part having a first magnetic pole center and a first inter-pole part and a second magnetic flux generating part having a second magnetic pole center and a second inter-pole part. The first inter-pole part and the second inter-pole part are shifted to each other in a circumferential direction.

### TECHNICAL FIELD

The present invention relates to a rotor.

### BACKGROUND

A proposed magnet for use in a rotor of a motor includes a driving magnetic field generating part (also referred to as a main magnetic flux generating part) to be used for rotation of the rotor and a detection magnetic field generating part (also referred to as a position detection magnetic flux generating part) for detecting a rotation position of the rotor (see, for example, Patent Reference 1). In the magnet described in Patent Reference 1, the driving magnetic field generating part and the detection magnetic field generating part are magnetized in a radial direction.

### PATENT REFERENCE

Patent Reference 1: Japanese Patent Application Publication No. 2000-287430

However, as in the conventional techniques, in a case where the position of an inter-pole part in the driving magnetic field generating part coincides with the position of an inter-pole part in the detection magnetic field generating part in a circumferential direction, magnetic flux from the driving magnetic field generating part may affect magnetic flux from the detection magnetic field generating part and thus there is a problem in that the accuracy in detecting the rotation position of a rotor decreases and the efficiency of the motor decreases.

### SUMMARY

It is, therefore, an object of the present invention to provide a rotor capable of enhancing motor efficiency.

A rotor according to the present invention includes: a resin magnet including a first magnetic flux generating part having a first magnetic pole center and a first inter-pole part and a second magnetic flux generating part having a second magnetic pole center and a second inter-pole part; and a shaft fixed to the resin magnet, and the first inter-pole part and the second inter-pole part are shifted to each other in a circumferential direction. The second magnetic flux generating part is adjacent to the first magnetic flux generating part in an axial direction. The first magnetic pole center and the second magnetic pole center are shifted to each other in the circumferential direction, and an outer diameter of the first magnetic flux generating part is larger than an outer diameter of the second magnetic flux generating part.

The present invention provides a rotor capable of enhancing motor efficiency.

### BRIEF DESCRIPTION OF THE DRAWINGS

FIG. 1 is a partial cross-sectional view schematically illustrating a structure of a motor according to a first embodiment of the present invention.

FIG. 2 is a partial cross-sectional view schematically illustrating a structure of a rotor.

FIG. 3 is a top view schematically illustrating a structure of a resin magnet.

FIG. 4 is a cross-sectional view of the resin magnet taken along a line C4-C4 in FIG. 3.

FIG. 5 is a bottom view schematically illustrating a structure of the resin magnet.

FIG. 6 is a diagram illustrating magnetic poles of the rotor.

FIG. 7 is a diagram illustrating a first orientation and a second orientation that are magnetic field orientations of the resin magnet.

FIG. 8 is a graph showing magnetic flux density distributions from a main magnetic flux generating part and a position detection magnetic flux generating part in a circumferential direction.

FIG. 9 is a graph showing a magnetic flux density distribution from 340 degrees to 380 degrees shown in FIG. 8.

FIG. 10 is a flowchart showing an example of a manufacturing process of a motor.

FIG. 11 is a diagram illustrating an example of a magnetization process in steps S5 and S6.

FIG. 12 is a partial cross-sectional view schematically illustrating a structure of a motor according to a variation.

FIG. 13 is a diagram illustrating a first orientation and a second orientation that are magnetic field orientations of a resin magnet in the motor according to the variation.

FIG. 14 is a diagram illustrating an example of a magnetization process in a method for manufacturing the motor according to the variation.

FIG. 15 is a diagram schematically illustrating a structure of a fan according to a second embodiment of the present invention.

FIG. 16 is a diagram schematically illustrating a configuration of an air conditioning apparatus according to a third embodiment of the present invention.

### DETAILED DESCRIPTION

### First Embodiment

In xyz orthogonal coordinate systems illustrated in the drawings, a z-axis direction (z axis) represents a direction parallel to an axis line Ax of a motor 1, an x-axis direction (x axis) represents a direction orthogonal to the z-axis direction (z axis), and a y-axis direction (y axis) is a direction orthogonal to both the z-axis direction and the x-axis direction. The axis Ax is a rotation center of the rotor 2. The direction parallel to the axis line Ax is also referred to as an “axial direction of the rotor 2” or simply an “axial direction.” A radial direction is a direction orthogonal to the axis line Ax. The “circumferential direction” refers to a circumferential direction of the rotor 2 and a resin magnet 21 about the axis line Ax.

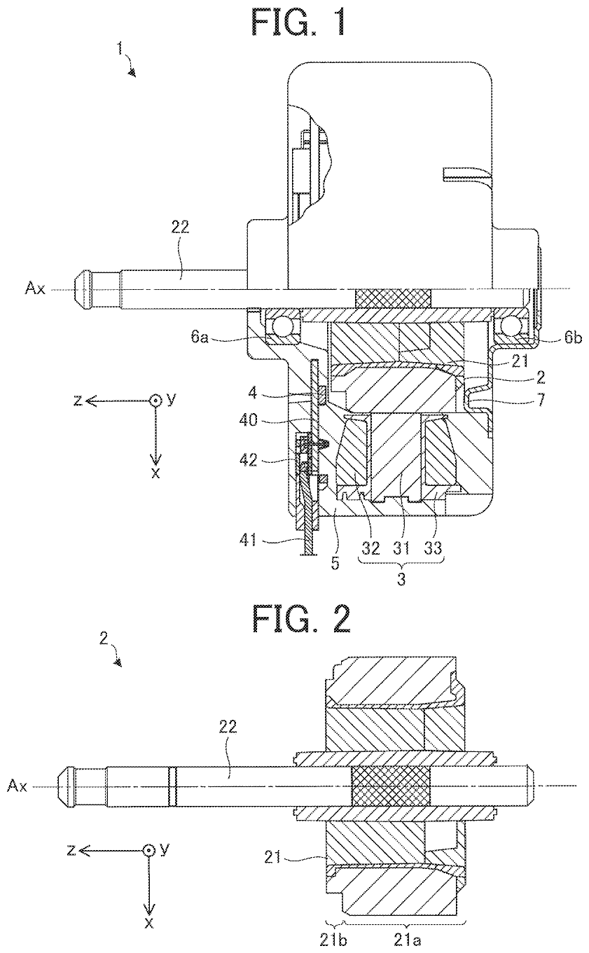

FIG. 1 is a partial cross-sectional view schematically illustrating a structure of the motor 1 according to a first embodiment of the present invention.

The motor 1 includes the rotor 2, a stator 3, and a position detection element 4 (also referred to as a magnetic pole position detection element 4). The motor 1 is also referred to as a molded motor.

In the example illustrated in FIG. 1, the motor 1 also includes a printed wiring board 40, a driving circuit 42, a resin 5, bearings 6a and 6b, and a bracket 7.

The motor 1 is, for example, a permanent magnet motor such as a permanent magnet synchronous motor. It should be noted that the motor 1 is not limited to the permanent magnet motor.

FIG. 2 is a partial cross-sectional view schematically illustrating a structure of the rotor 2.

The rotor 2 includes a resin magnet 21 and a shaft 22. The rotor 2 is rotatable about a rotation axis (i.e., the axis line Ax). The rotor 2 is rotatably disposed inside the stator 3 with a gap in between. The shaft 22 is fixed to the resin magnet 21. The bearings 6a and 6b rotatably support both ends of the shaft 22 of the rotor 2.

The resin magnet 21 is formed by mixing magnetic particles such as ferrite and samarium-iron-nitrogen with a thermoplastic resin such as Nylon 12 and Nylon 6.

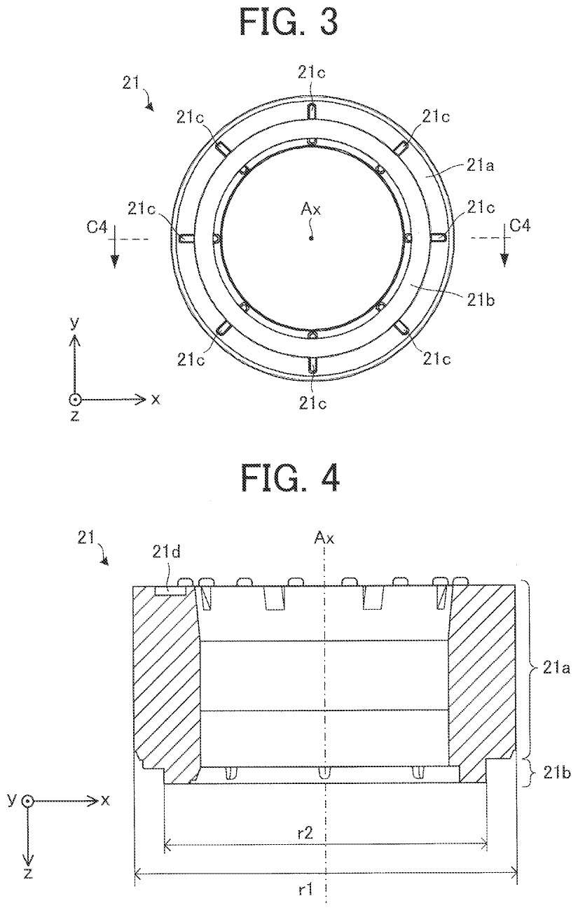

FIG. 3 is a top view schematically illustrating a structure of the resin magnet 21.

FIG. 4 is a cross-sectional view of the resin magnet 21 taken along a line C4-C4 in FIG. 3.

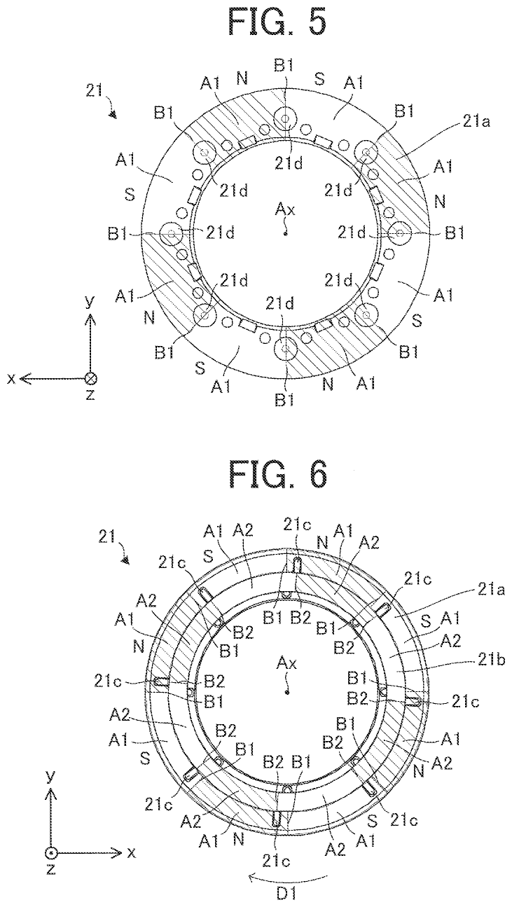

FIG. 5 is a bottom view schematically illustrating a structure of the resin magnet 21.

FIG. 6 is a diagram illustrating magnetic poles of the rotor 2, specifically the resin magnet 21. In FIG. 6, “N” represents a north pole, and “S” represents a south pole.

The resin magnet 21 has magnetic field orientations of two different types, specifically, a first orientation R1 and a second orientation R2 that are different from each other. More specifically, the resin magnet 21 includes a main magnetic flux generating part 21a serving as a first magnetic flux generating part having the first orientation R1 and a position detection magnetic flux generating part 21b serving as a second magnetic flux generating part having the second orientation R2 different from the first orientation R1.

The main magnetic flux generating part 21a includes a first magnetic pole center A1 and a first inter-pole part B1. The position detection magnetic flux generating part 21b includes a second magnetic pole center A2 and a second inter-pole part B2.

The magnetic pole center refers to the center of a magnetic pole of the resin magnet 21, for example, refers to the center of a north pole or the center of a south pole. That is, the first magnetic pole center A1 refers to the center of a magnetic pole of the main magnetic flux generating part 21a, and the second magnetic pole center A2 refers to the center of a magnetic pole of the position detection magnetic flux generating part 21b.

The inter-pole part is a boundary between a north pole and a south pole. That is, the first inter-pole part B1 is a boundary between the north pole and the south pole of the main magnetic flux generating part 21a, and the second inter-pole part B2 is a boundary between the north pole and the south pole of the position detection magnetic flux generating part 21b.

In the examples illustrated in FIGS. 3 through 6, the main magnetic flux generating part 21a has a cylindrical shape, and the position detection magnetic flux generating part 21b also has a cylindrical shape.

The position detection magnetic flux generating part 21b is located at an end portion of the resin magnet 21 in the axial direction so as to face the position detection element 4. Accordingly, the position detection magnetic flux generating part 21b is located between the main magnetic flux generating part 21a and the position detection element 4.

The inner surface of the main magnetic flux generating part 21a or the position detection magnetic flux generating part 21b may have a projection to be engaged with the shaft 22 (e.g., a groove formed on the surface of the shaft 22). In this manner, displacement of the resin magnet 21 can be avoided.

As illustrated in FIGS. 4 and 5, the resin magnet 21 includes at least one gate part 21d. The gate part 21d will also be referred to simply as a “gate.”

In the example illustrated in FIGS. 4 and 5, the gate part 21d is formed in an end portion of the resin magnet 21 in the axial direction. Specifically, the gate part 21d is formed in each first inter-pole part B1. The position detection magnetic flux generating part 21b is located at a side opposite to the gate part 21d in the axial direction. Accordingly, the distinction between the first orientation R1 and the second orientation R2 can be made clearly.

The gate part 21d is a gate mark formed at a gate position in a die in the process of molding the resin magnet 21 using the die. In the example illustrated in FIGS. 4 and 5, the gate part 21d is a depression. In addition, the gate parts 21d may be formed at both ends of the resin magnet 21 in the axial direction. Accordingly, the first orientation R1 and the second orientation R2 that are different from each other can be formed easily.

In the example illustrated in FIGS. 5 and 6, hatched portions of the resin magnet 21 serve as north poles, and unhatched portions of the resin magnet 21 serve as south poles.

As illustrated in FIG. 6, the first magnetic pole center A1 and the second magnetic pole center A2 are shifted to each other in a circumferential direction. Specifically, the second magnetic pole center A2 is shifted from the first magnetic pole center A1 to a downstream side in a rotation direction D1 of the rotor 2. Thus, the first inter-pole part B1 and the second inter-pole part B2 are shifted to each other in the circumferential direction. Specifically, the second inter-pole part B2 is shifted from the first inter-pole part B1 to the downstream side in the rotation direction D1 of the rotor 2.

As illustrated in FIGS. 3 and 6, the resin magnet 21 includes at least one projection 21c projecting toward the position detection element 4. In the example illustrated in FIGS. 3 and 6, the resin magnet 21 includes a plurality of projections 21c. A position of each of the projections 21c coincides with a position of the second inter-pole part B2 in the circumferential direction.

Accordingly, when the second inter-pole part B2 of the resin magnet 21 passes by the position detection element 4, the orientation of magnetic flux flowing into the position detection element 4 can be changed abruptly. That is, it is possible to enhance the accuracy of detection of the second inter-pole part (i.e., a point of change from the north pole to the south pole or from the south pole to the north pole) detected by the position detection element 4. As a result, the accuracy of detection of the rotation position of the rotor 2 (specifically, the resin magnet 21) can be enhanced.

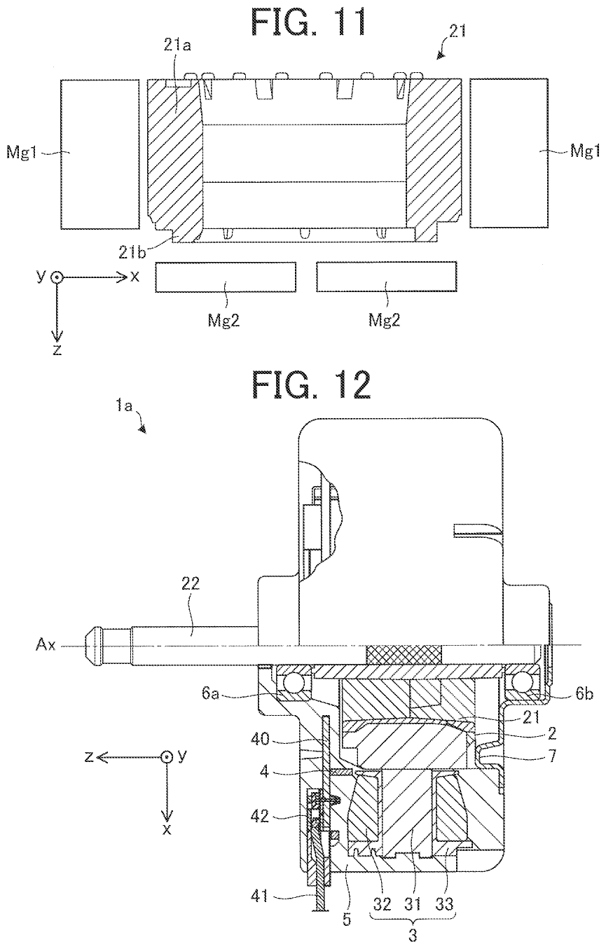

As illustrated in FIG. 4, the relationship between r1 and r2 satisfies r1≥r2 where r1 is the outer diameter of the main magnetic flux generating part 21a, and r2 is the outer diameter of the position detection magnetic flux generating part 21b. Accordingly, in the magnetization process on the main magnetic flux generating part 21a, it is possible to reduce magnetization of the position detection magnetic flux generating part 21b by a permanent magnet Mg1 (see FIG. 11 described later) for magnetizing the permanent magnet main magnetic flux generating part 21a. That is, in the magnetization process on the main magnetic flux generating part 21a, the influence on the orientation (i.e., the second orientation R2) of the position detection magnetic flux generating part 21b can be reduced. As a result, the accuracy of detection of magnetic flux from the position detection magnetic flux generating part 21b, that is, the accuracy of detection of the rotation position of the rotor 2 (specifically, the resin magnet 21) can be enhanced.

In addition, the relationship between r1 and r2 preferably satisfies r1>r2. In this manner, in the magnetization process on the main magnetic flux generating part 21a, the influence on the orientation of the position detection magnetic flux generating part 21b can be further reduced. As a result, the accuracy of detection of magnetic flux from the position detection magnetic flux generating part 21b can be further enhanced.

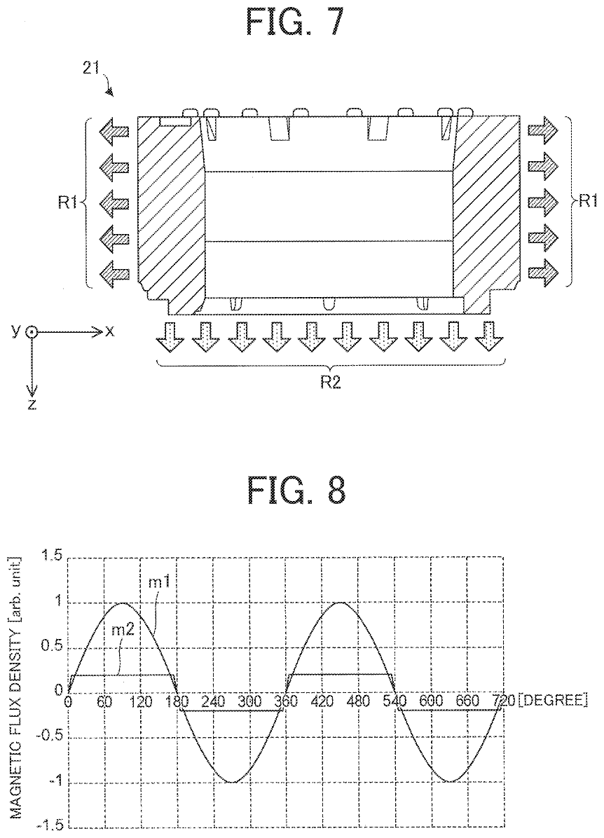

FIG. 7 is a diagram illustrating the first orientation R1 and the second orientation R2 that are magnetic field orientations of the resin magnet 21. In the example illustrated in FIG. 7, orientations in the xz plane (specifically a plane along the line C4-C4 in FIG. 3), that is, the first orientation R1 and the second orientation R2 are illustrated.

FIG. 8 is a graph showing magnetic flux density distributions from the main magnetic flux generating part 21a and the position detection magnetic flux generating part 21b in the circumferential direction. In FIG. 8, the vertical axis represents a magnetic flux density [arbitrary unit], and the horizontal axis represents a rotation angle [degree] of the rotor 2.

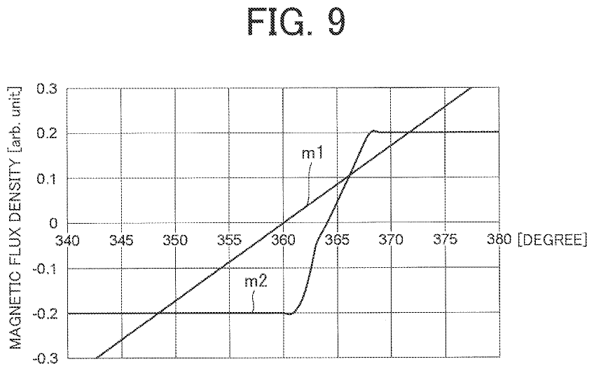

FIG. 9 is a graph showing a magnetic flux density distribution from 340 degrees to 380 degrees shown in FIG. 8.

The main magnetic flux generating part 21a is magnetized so as to have the first orientation R1. In the example illustrated in FIG. 7, the first orientation R1 is a polar anisotropic orientation. The magnetic flux density distribution of the main magnetic flux generating part 21a in the circumferential direction is represented by a waveform m1 in FIG. 8. That is, the main magnetic flux generating part 21a is magnetized so that detection values of magnetic flux detected by the position detection element 4 form a sine wave. That is, the first orientation R1 is an orientation in which detection values of magnetic flux detected by the position detection element 4 form a sine wave.

The position detection magnetic flux generating part 21b is magnetized so as to have the second orientation R2. The first orientation R1 and the second orientation R2 are have different orientations. In the example illustrated in FIG. 7, the second orientation R2 is an axial orientation. The magnetic flux density distribution of the position detection magnetic flux generating part 21b in the circumferential direction is represented by a waveform m2 in FIG. 8. That is, the position detection magnetic flux generating part 21b is magnetized so that detection values of magnetic flux detected by the position detection element 4 form a rectangular wave. That is, the second orientation R2 is an orientation in which detection values of magnetic flux detected by the position detection element 4 form a rectangular wave.

As described above, the second inter-pole part B2 is shifted from the first inter-pole part B1 to the downstream side in the rotation direction D1 of the rotor 2. Accordingly, a phase difference occurs between a magnetic flux density of the main magnetic flux generating part 21a and a magnetic flux density of the position detection magnetic flux generating part 21b. As illustrated in FIG. 9, the waveform m2 is a leading phase with respect to the waveform m1. That is, a phase of the magnetic flux density of the position detection magnetic flux generating part 21b leads a phase of the magnetic flux density of the main magnetic flux generating part 21a. For example, the amount of positional shift of the second inter-pole part B2 from the first inter-pole part B1 is greater than zero degrees and smaller than 10 degrees in terms of an electrical angle. Preferably, the amount of positional shift of the second inter-pole part B2 from the first inter-pole part B1 is greater than zero degrees and smaller than 5 degrees in terms of an electrical angle.

As illustrated in FIG. 8, a peak of a magnetic flux density represented by the waveform m1 is larger than a peak of a magnetic flux density represented by the waveform m2. As shown in FIG. 9, the tilt of the waveform m2 in the second inter-pole part B2 (near 365 degrees in FIG. 9) is larger than the tilt of the waveform m1 in the first inter-pole part B1 (near 360 degrees in FIG. 9). In other words, the tilt of the waveform m2 representing the position of the second inter-pole part B2 detected by the position detection element 4 is larger than the tilt of the waveform m1 representing the position of the first inter-pole part B1 detected by the position detection element 4.

That is, in the circumferential direction, a change of orientation of magnetic flux from the position detection magnetic flux generating part 21b (i.e., from the north pole to the south pole or from the south pole to the north pole) occurs more rapidly than a change of orientation of magnetic flux from the main magnetic flux generating part 21a (i.e., from the north pole to the south pole or from the south pole to the north pole). Thus, the influence on magnetic flux of the position detection magnetic flux generating part 21b from the main magnetic flux generating part 21a, that is, noise of the motor 1, can be reduced. In addition, by detecting the position of the second inter-pole part B2 using the position detection element 4, the accuracy of detection of the rotation position of the rotor 2 can be enhanced.

The stator 3 includes a stator core 31, a winding 32, and an insulator 33 serving as an insulating part. The stator core 31 is formed of, for example, a plurality of electromagnetic steel sheets. In this case, the plurality of electromagnetic steel sheets are laminated in the axial direction. Each of the plurality of electromagnetic steel sheets is formed in a predetermined shape by punching, and the resulting electromagnetic steel sheets are fixed to each other by caulking, welding, bonding, or the like.

As illustrated in FIG. 1, the motor 1 may include the printed wiring board 40, a lead wire 41 connected to the printed wiring board 40, and the driving circuit 42 fixed to a surface of the printed wiring board 40. In this case, the position detection element 4 is attached to the printed wiring board 40 so as to face the resin magnet 21, specifically, the position detection magnetic flux generating part 21b.

The winding 32 is, for example, a magnet wire. The winding 32 is wound around the insulator 33 combined with the stator core 31 to thereby form a coil. An end portion of the winding 32 is connected to a terminal attached to the printed wiring board 40 by fusing or soldering.

The insulator 33 is, for example, a thermoplastic resin such as polybutylene terephthalate (PBT). The insulator 33 electrically insulates the stator core 31. The insulator 33 is molded unitedly with the stator core 31, for example. Alternatively, the insulator 33 may be previously molded, and the molded insulator 33 may be combined with the stator core 31.

The driving circuit 42 controls rotation of the rotor 2. The driving circuit 42 is, for example, a power transistor. The driving circuit 42 is electrically connected to the winding 32, and supplies, to the winding 32, a coil current based on a current supplied from the outside or inside (e.g., a battery) of the motor 1. In this manner, the driving circuit 42 controls rotation of the rotor 2.

The position detection element 4 faces the resin magnet 21 in the axial direction. Specifically, the position detection element 4 faces the position detection magnetic flux generating part 21b in the axial direction. The position detection element 4 detects a position of the second inter-pole part B2. Specifically, the position detection element 4 detects a change of orientation of magnetic flux (i.e., from the north pole to the south pole or from the south pole to the north pole) from the position detection magnetic flux generating part 21b to thereby detect a position of a magnetic pole of the rotor 2, that is, the rotation position of the rotor 2. The position detection element 4 is, for example, a Hall IC.

The resin 5 is, for example, a thermosetting resin such as a bulk molding compound (BMC). The stator 3 and the printed wiring board 40 are united with the resin 5. The position detection element 4 is attached to the printed wiring board 40. Thus, the position detection element 4 is also united with the stator 3 by using the resin 5. The printed wiring board 40 (including the position detection element 4) and the stator 3 will be referred to as a stator assembly. The printed wiring board 40 (including the position detection element 4), the stator 3, and the resin 5 will be referred to as a mold stator.

An example of a method for manufacturing the motor 1 will be described below.

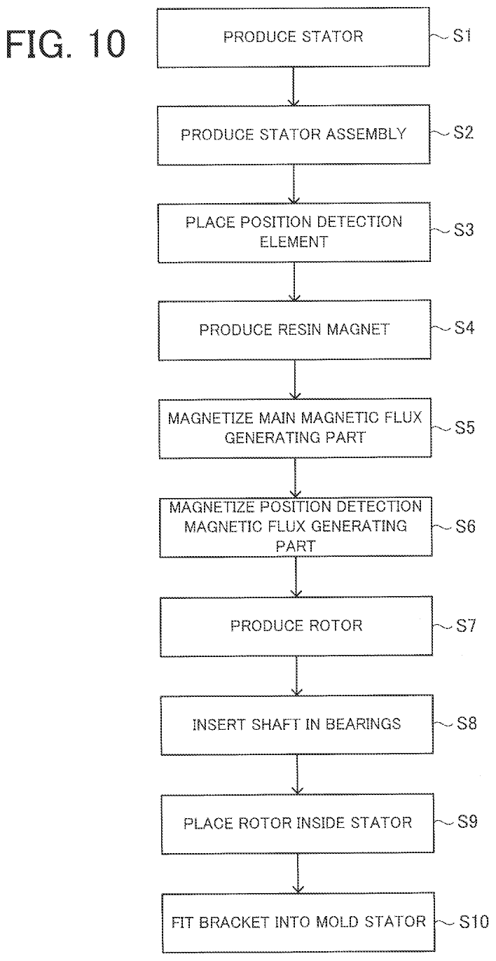

FIG. 10 is a flowchart showing an example of a manufacturing process of the motor 1. In this embodiment, the method for manufacturing the motor 1 includes steps described below. The method for manufacturing the motor 1, however, is not limited to this embodiment.

In step S1, the stator 3 is produced. For example, the stator core 31 is formed by laminating a plurality of electromagnetic steel sheets in the axial direction. In addition, the previously formed insulator 33 is attached to the stator core 31, and the winding 32 is wound around the stator core 31 and the insulator 33. In this manner, the stator 3 is obtained.

In step S2, a stator assembly is produced. For example, projections of the insulator 33 are inserted in positioning holes of the printed wiring board 40. Accordingly, the printed wiring board 40 is positioned, and a stator assembly is obtained. In this embodiment, the position detection element 4 and the driving circuit 42 are previously fixed to a surface of the printed wiring board 40. The lead wire 41 is also preferably attached to the printed wiring board 40 beforehand. The projections of the insulator 33 projecting from the positioning holes of the printed wiring board 40 may be fixed to the printed wiring board 40 by heat welding, ultrasonic welding, or the like.

In step S3, the position detection element 4 is placed so as to face the resin magnet 21. Specifically, in step S3, the printed wiring board 40 and the stator 3 are united by using the resin 5. In this case, the printed wiring board 40 is placed at a position where the position detection element 4 on the printed wiring board 40 faces the resin magnet 21, specifically, the position detection magnetic flux generating part 21b. For example, the stator 3 and the printed wiring board 40 are placed in a die, and a material for the resin 5 (e.g., a thermosetting resin such as bulk molding compound) is poured into the die. In this manner, a mold stator is obtained.

In step S4, the resin magnet 21 is produced. Magnetic particles such as ferrite or samarium-iron-nitrogen are mixed with a thermoplastic resin such as Nylon 12 or Nylon 6, and the resin magnet 21 is molded by using a die. In this manner, the resin magnet 21 having the structure described above is produced.

FIG. 11 is a diagram illustrating an example of a magnetization process in steps S5 and S6.

In step S5, the main magnetic flux generating part 21a that is a part of the resin magnet 21 is magnetized so as to have the first orientation R1. Specifically, as illustrated in FIG. 11, the permanent magnet Mg1 for magnetization as a first orientation yoke (also referred to as a first magnetization yoke) is placed so as to face the outer peripheral surface of the main magnetic flux generating part 21a of the resin magnet 21, and the main magnetic flux generating part 21a is magnetized. That is, the main magnetic flux generating part 21a is magnetized so as to have the first orientation R1 by using the permanent magnet Mg1. Instead of the permanent magnet Mg1, a magnetization coil may be used as the first orientation yoke.

In step S6, the position detection magnetic flux generating part 21b that is another part of the resin magnet 21 is magnetized so as to have the second orientation R2 different from the first orientation R1. Specifically, as illustrated in FIG. 11, a permanent magnet Mg2 for magnetization as a second orientation yoke (also referred to as a second magnetization yoke) is placed so as to face the position detection magnetic flux generating part 21b of the resin magnet 21 in the axial direction, and the position detection magnetic flux generating part 21b is magnetized so as to have the structure described above. That is, the position detection magnetic flux generating part 21b is magnetized so as to have the second orientation R2 by using the permanent magnet Mg2. In this case, the resin magnet, specifically, the position detection magnetic flux generating part 21b, is magnetized so that the first inter-pole part B1 and the second inter-pole part B2 are shifted to each other in the circumferential direction. More specifically, the position detection magnetic flux generating part 21b is magnetized so that the second inter-pole part B2 is shifted from the first inter-pole part B1 to the downstream side in the rotation direction D1 of the rotor 2. Instead of the permanent magnet Mg2, a magnetization coil may be used as the second orientation yoke.

In step S7, the rotor 2 is produced. For example, the shaft 22 is inserted in a shaft hole formed in the resin magnet 21, and the shaft 22 is fixed to the resin magnet 21. The shaft 22 is united with the resin magnet 21 by using, for example, a thermoplastic resin such as polybutylene terephthalate (PBT). In this manner, the rotor 2 is obtained. The resin magnet 21 and the shaft 22 may be made of different materials or may be made of the same material. The resin magnet 21 and the shaft 22 may be integrally formed of the same material.

In step S8, the shaft 22 is inserted in the bearings 6a and 6b.

In step S9, the rotor 2 is inserted, together with the bearings 6a and 6b, into the stator assembly (specifically, the stator 3). In this manner, the rotor 2 (specifically, the resin magnet 21) is placed inside the stator 3.

In step S10, the bracket 7 is fitted into the mold stator (specifically, the resin 5).

The order of step S1 through step S10 is not limited to the order shown in FIG. 10. For example, steps S1 to S3 and steps S4 to S7 may be performed concurrently. Steps S4 to S7 may be performed prior to steps S1 to S3.

Through the steps described above, the motor 1 is fabricated.

In the motor 1 according to the first embodiment, the first inter-pole part B1 and the second inter-pole part B2 are shifted to each other in the circumferential direction. Accordingly, as shown in FIG. 9, a phase difference can be caused to occur between the magnetic flux density of the main magnetic flux generating part 21a and the magnetic flux density of the position detection magnetic flux generating part 21b. That is, a phase difference can be caused to occur between a phase of an induced voltage generated by magnetic flux of the main magnetic flux generating part 21a and a phase of a coil current (i.e., a current flowing in the winding 32) controlled by magnetic flux flowing into the position detection element 4. Accordingly, the position detection element 4 easily detects the position of the second inter-pole part B2 and thus the accuracy of detection of the rotation position of the rotor 2 can be enhanced. As a result, efficiency of the motor 1 can be increased.

The second inter-pole part B2 is shifted from the first inter-pole part B1 to the downstream side in the rotation direction D1 of the rotor 2. That is, a phase of the magnetic flux density of the position detection magnetic flux generating part 21b leads a phase of the magnetic flux density of the main magnetic flux generating part 21a. Thus, a coil current (i.e., a current flowing in the winding 32) is controlled so that the phase of the coil current is a leading phase with respect to the induced current generated by magnetic flux of the main magnetic flux generating part 21a. Accordingly, a reluctance torque can be used as well as a magnet torque of the resin magnet 21, and thus, efficiency of the motor 1 can be further increased.

In addition, as shown in FIG. 9, a tilt of the waveform m2 is larger than a tilt of the waveform m1 near an inter-pole part. That is, a change in an orientation of magnetic flux from the position detection magnetic flux generating part 21b (i.e., from the north pole to the south pole or from the south pole to the north pole) is performed more rapidly than a change of an orientation of magnetic flux from the main magnetic flux generating part 21a (i.e., from the north pole to the south pole or from the south pole to the north pole). Thus, by detecting the position of the second inter-pole part B2 using the position detection element 4, the accuracy of detection of the rotation position of the rotor 2 can be enhanced.

The rotor 2 has the first orientation R1 and the second orientation R2 that are different from each other. Specifically, since the first orientation R1 is an orientation in which detection values of magnetic flux detected by the position detection element 4 form a sine wave, noise of the motor 1 can be reduced. In addition, since the second orientation R2 is an orientation in which detection values of magnetic flux detected by the position detection element 4 form a rectangular wave, the accuracy of detection of the rotation position of the rotor 2 can be enhanced.

In addition, since the position detection element 4 faces the resin magnet 21, specifically, the position detection magnetic flux generating part 21b, in the axial direction, a flow of magnetic flux from the main magnetic flux generating part 21a into the position detection element 4 can be reduced, and the accuracy of detection of magnetic flux from the position detection magnetic flux generating part 21b can be enhanced. As a result, the accuracy of detection of the rotation position of the rotor 2 can be enhanced.

In a case where the position detection element 4 faces the position detection magnetic flux generating part 21b in the axial direction, the position detection element 4 can be attached to the printed wiring board 40. In this manner, the size of the motor 1 can be reduced, and costs for the motor 1 can be reduced.

If the relationship between r1 and r2 satisfies r1≥r2, in the magnetization process on the main magnetic flux generating part 21a, it is possible to reduce magnetization of the position detection magnetic flux generating part 21b by the permanent magnet Mg1 for magnetization on the main magnetic flux generating part 21a. As a result, the accuracy of detection of magnetic flux from the position detection magnetic flux generating part 21b, that is, the accuracy of detection of a position of a magnetic pole of the rotor 2 (specifically, the resin magnet 21) can be enhanced.

The resin magnet 21 has a projection that is located at a position corresponding to a position of the second inter-pole part B2 in the circumferential direction and projects toward the position detection element 4. Accordingly, when the second inter-pole part B2 of the resin magnet 21 passes by the position detection element 4, the orientation of magnetic flux flowing into the position detection element 4 can be changed abruptly. That is, it is possible to enhance the accuracy of detection of the second inter-pole part B2 (i.e., a point of change from the north pole to the south pole or from the south pole to the north pole) detected by the position detection element 4. As a result, the accuracy of detection of the rotation position of the rotor 2 (specifically, the resin magnet 21) can be enhanced.

With the method for manufacturing the motor 1 according to the first embodiment, the step of magnetizing the main magnetic flux generating part 21a having the first orientation R1 and the step of magnetizing the position detection magnetic flux generating part 21b having the second orientation R2 are performed separately, and thus, the first orientation R1 and the second orientation R2 can be clearly distinguished. Specifically, in step S6, the permanent magnet Mg2 is disposed so as to face the position detection magnetic flux generating part 21b of the resin magnet 21 in the axial direction, and the position detection magnetic flux generating part 21b is magnetized. In this manner, a magnetic flux density flowing in the axial direction can be increased. As a result, a magnetic force of the resin magnet 21 can be increased, and the accuracy of detection of the rotation position of the rotor 2 (specifically, the resin magnet 21) can be enhanced. Accordingly, the rotor 2 capable of enhancing efficiency of the motor 1 can be provided.

### Variation

FIG. 12 is a partial cross-sectional view schematically illustrating a motor 1a according to a variation.

In the motor 1a, the position detection element 4 faces the resin magnet 21 in the radial direction. Specifically, the position detection element 4 faces the position detection magnetic flux generating part 21b in the radial direction. That is, with respect to the position detection element 4 of the motor 1a, the location of the position detection element 4 is different from that of the first embodiment.

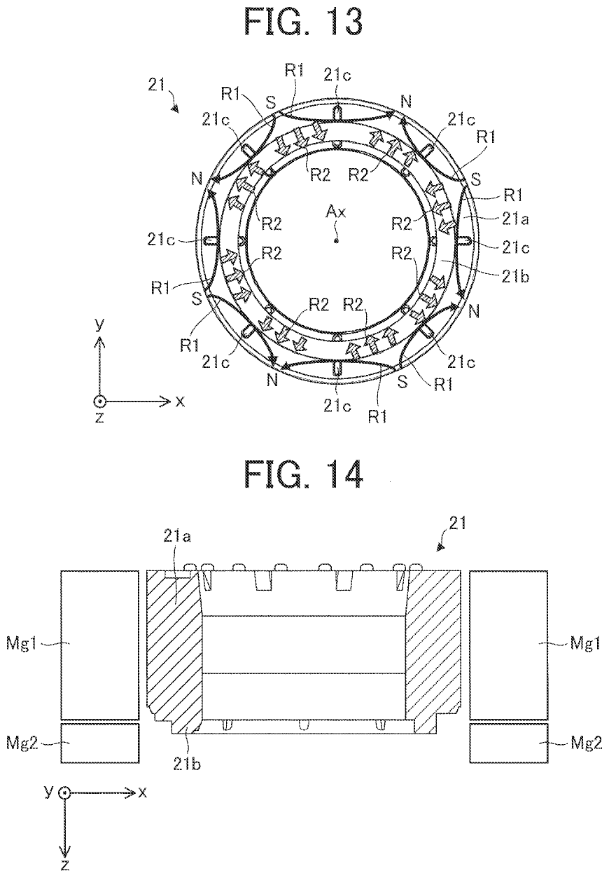

FIG. 13 is a diagram illustrating a first orientation R1 and a second orientation R2 that are magnetic field orientations of a resin magnet 21 in the motor 1a. In the motor 1a, the first orientation R1 is a polar anisotropic orientation, and the second orientation R2 is a radial orientation. That is, in the motor 1a, the second orientation R2 is different from that described in the first embodiment.

The other features of the motor 1a are the same as those of the first embodiment.

In the motor 1a according to the variation, the same advantages as those described in the first embodiment can also be obtained. In addition, in the motor 1a, the position detection element 4 is disposed so as to face the position detection magnetic flux generating part 21b in the radial direction. Accordingly, the size of the motor 1a can be further reduced. In this case, since the second orientation R2 is a radial orientation, magnetic flux from the position detection magnetic flux generating part 21b easily flows into the position detection element 4. As a result, the accuracy of detection of the rotation position of the rotor 2 can be enhanced.

In a method for manufacturing the motor 1a according to the variation, processes in steps S5 and S6 are different from step S6 in the manufacturing process of the motor 1. Specifically, in the method for manufacturing the motor 1a according to the variation, the processes in steps S5 and S6 described above are performed at the same time. That is, magnetization on the main magnetic flux generating part 21a and magnetization on the position detection magnetic flux generating part 21b are performed at the same time.

FIG. 14 is a diagram illustrating an example of a magnetization process in a method for manufacturing the motor 1a according to the variation.

As illustrated in FIG. 14, the permanent magnet Mg1 for magnetization as the first orientation yoke (also referred to as the first magnetization yoke) is placed so as to face the outer peripheral surface of the main magnetic flux generating part 21a of the resin magnet 21, and the permanent magnet Mg2 for magnetization as the second orientation yoke (also referred to as the second magnetization yoke) is placed so as to face the position detection magnetic flux generating part 21b of the resin magnet 21 in the radial direction. In this state, magnetization on the main magnetic flux generating part 21a and magnetization on the position detection magnetic flux generating part 21b are performed at the same time. In this manner, the main magnetic flux generating part 21a that is a part of the resin magnet 21 is magnetized so as to have the first orientation R1, and the position detection magnetic flux generating part 21b that is another part of the resin magnet 21 is magnetized so as to have the second orientation R2 different from the first orientation R1.

In the method for manufacturing the motor 1a according to the variation, magnetization on the main magnetic flux generating part 21a and magnetization on the position detection magnetic flux generating part 21b are performed at the same time, and thus, manufacturing processes can be simplified.

### Second Embodiment

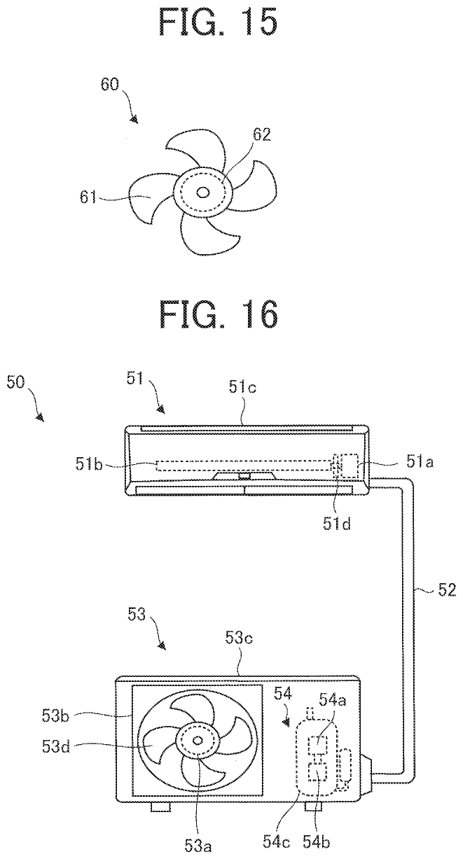

FIG. 15 is a diagram schematically illustrating a structure of a fan 60 according to a second embodiment of the present invention.

The fan 60 includes blades 61 and a motor 62. The fan 60 is also referred to as an air blower. The motor 62 is the motor 1 according to the first embodiment (including the variation thereof). The blades 61 are fixed to a shaft (e.g., the shaft 22 in the first embodiment) of the motor 62. The motor 62 drives the blades 61. When the motor 62 is driven, the blades 61 rotate and thus an airflow is generated. Accordingly, the fan 60 can send air.

With the fan 60 according to the second embodiment, the motor 1 described in the first embodiment (including the variation thereof) is applied to the motor 62, and thus, the same advantages as those described in the first embodiment can be obtained. As a result, noise of the fan 60 can be reduced, and control of the fan 60 can be improved.

### Third Embodiment

An air conditioning apparatus 50 according to a third embodiment of the present invention will be described.

FIG. 16 is a diagram schematically illustrating a configuration of the air conditioning apparatus 50 according to the third embodiment of the present invention.

The air conditioning apparatus 50 (e.g., a refrigeration air conditioning apparatus) according to the third embodiment includes an indoor unit 51 serving as an air blower (first air blower), a refrigerant pipe 52, and an outdoor unit 53 serving as an air blower (second air blower) connected to the indoor unit 51 by the refrigerant pipe 52.

The indoor unit 51 includes a motor 51a (e.g., the motor 1 according to the first embodiment), an air supply unit 51b that is driven by the motor 51a to thereby send air, and a housing 51c covering the motor 51a and the air supply unit 51b. The air supply unit 51b includes blades 51d that are driven by the motor 51a, for example. For example, the blades 51d are fixed to a shaft (e.g., the shaft 22 in the first embodiment) of the motor 51a, and generates an airflow.

The outdoor unit 53 includes a motor 53a (e.g., the motor 1 according to the first embodiment), an air supply unit 53b, a compressor 54, and a heat exchanger (not shown). The air supply unit 53b is driven by the motor 53a to thereby send air. The air supply unit 53b includes blades 53d that are driven by the motor 53a, for example. For example, the blades 53d are fixed to a shaft (e.g., the shaft 22 in the first embodiment) of the motor 53a, and generate an airflow. The compressor 54 includes a motor 54a (e.g., the motor 1 according to the first embodiment), a compression mechanism 54b (e.g., a refrigerant circuit) that is driven by the motor 54a, and a housing 54c covering the motor 54a and the compression mechanism 54b.

In the air conditioning apparatus 50, at least one of the indoor unit 51 or the outdoor unit 53 includes the motor 1 described in the first embodiment (including the variation thereof). Specifically, as a driving source of the air supply unit, the motor 1 described in the first embodiment (including the variation thereof) is applied to at least one of the motors 51a or 53a. In addition, as the motor 54a of the compressor 54, the motor 1 described in the first embodiment (including the variation thereof) may be used.

The air conditioning apparatus 50 can perform operations such as a cooling operation of sending cold air and a heating operation of sending warm air from the indoor unit 51. In the indoor unit 51, the motor 51a is a driving source for driving the air supply unit 51b. The air supply unit 51b is capable of sending conditioned air.

In the air conditioning apparatus 50 according to the third embodiment, the motor 1 described in the first embodiment (including the variation thereof) is applied to at least one of the motors 51a or 53a, and thus, the same advantages as those described in the first embodiment can be obtained. Accordingly, noise of the air conditioning apparatus 50 can be reduced, and control of the air conditioning apparatus 50 can be improved. In addition, with the use of the low-cost motor 1, costs for the air conditioning apparatus 50 can also be reduced.

In addition, the use of the motor 1 according to the first embodiment (including the variation thereof) as a driving source of the air blower (e.g., the indoor unit 51) can obtain the same advantages as those described in the first embodiment. Accordingly, noise of the air blower can be reduced, and control of the air blower can be improved. The air blower including the motor 1 according to the first embodiment and blades (e.g., the blades 51d or 53d) driven by the motor 1 can be used alone as a device for sending air. This air blower is also applicable to equipment other than the air conditioning apparatus 50.

In addition, the use of the motor 1 according to the first embodiment (including the variation thereof) as a driving source of the compressor 54 can obtain the same advantages as those described in the first embodiment. Accordingly, noise of the compressor 54 can be reduced, and control of the compressor 54 can be improved.

The motor 1 described in the first embodiment (including the variation thereof) can be mounted on equipment including a driving source, such as a ventilator, a household electrical appliance, or a machine tool, in addition to the air conditioning apparatus 50.

Features of the embodiments described above can be combined as appropriate.

1. A rotor comprising:
a resin magnet including a first magnetic flux generating part having a first magnetic pole center and a first inter-pole part and a second magnetic flux generating part having a second magnetic pole center and a second inter-pole part, the second magnetic flux generating part being adjacent to the first magnetic flux generating part in an axial direction; and
a shaft fixed to the resin magnet, wherein
the first inter-pole part and the second inter-pole part are shifted to each other in a circumferential direction,
the first magnetic pole center and the second magnetic pole center are shifted to each other in the circumferential direction, and
an outer diameter of the first magnetic flux generating part is larger than an outer diameter of the second magnetic flux generating part.

2. The rotor according to claim 1, wherein the second inter-pole part is shifted from the first inter-pole part to a downstream side in a rotation direction of the rotor.

3. The rotor according to claim 2, wherein an amount of shift of a position of the second inter-pole part from a position of the first inter-pole part is greater than zero degrees and smaller than 10 degrees in terms of an electrical angle.

4. The rotor according to claim 1, wherein in the circumferential direction, a change of an orientation of magnetic flux from the second magnetic flux generating part occurs more rapidly than a change of an orientation of magnetic flux from the first magnetic flux generating part.

5. The rotor according to claim 1, wherein
the first magnetic flux generating part has a first orientation, and
the second magnetic flux generating part has a second orientation different from the first orientation.

6. The rotor according to claim 5, wherein
the first orientation is a polar anisotropic orientation, and
the second orientation is an axial orientation.

7. The rotor according to claim 5, wherein
the first orientation is a polar anisotropic orientation, and
the second orientation is a radial orientation.

8. The rotor according to claim 1, wherein the second magnetic flux generating part is located at an end portion of the resin magnet in an axial direction.

9. A motor comprising:
the rotor according to claim 1;
a stator; and
a position detection element to detect a rotation position of the rotor.

10. The motor according to claim 9, wherein a tilt of a waveform representing a position of the second inter-pole part detected by the position detection element is larger than a tilt of a waveform representing a position of the first inter-pole part detected by the position detection element.

11. The motor according to claim 9, wherein the position detection element faces the second magnetic flux generating part in an axial direction.

12. The motor according to claim 11, wherein
the first magnetic flux generating part has a polar anisotropic orientation, and
the second magnetic flux generating part has an axial orientation.

13. The motor according to claim 9, wherein the position detection element faces the second magnetic flux generating part in a radial direction.

14. The motor according to claim 13, wherein
the first magnetic flux generating part has a polar anisotropic orientation, and
the second magnetic flux generating part has a radial orientation.

15. The motor according to claim 1, wherein the resin magnet has a projection located at a position coinciding with a position of the second inter-pole part in the circumferential direction, the projection projecting toward the position detection element.

16. A fan comprising:
a blade; and
the motor to drive the blade, according to claim 9.

17. An air conditioning apparatus comprising:
an indoor unit; and
an outdoor unit connected to the indoor unit, wherein
at least one of the indoor unit or the outdoor unit includes the motor according to claim 9.

18. A method for manufacturing a rotor, the rotor including a resin magnet including a first magnetic flux generating part having a first magnetic pole center and a first inter-pole part and a second magnetic flux generating part having a second magnetic pole center and a second inter-pole part, the method comprising:
producing the resin magnet so that the second magnetic flux generating part is adjacent to the first magnetic flux generating part in an axial direction; and
magnetizing the resin magnet so that the first inter-pole part and the second inter-pole part are shifted to each other in a circumferential direction, wherein
the first magnetic pole center and the second magnetic pole center are shifted to each other in the circumferential direction, and
an outer diameter of the first magnetic flux generating part is larger than an outer diameter of the second magnetic flux generating part.
